(19) United States
(12) Patent Application Publication
(10) Pub. No.: US 2008/0013331 A1
(43) Pub. Date: Jan. 17, 2008

(54) Vehicular rotatable lamp assembly having angle correction mechanism

(76) Inventor: Chian-Yin Tseng, Tainan City (TW)

Correspondence Address: Paul D. Greeley;Ohlandt, Greeley, Ruggiero & Perle, L.L.P., 10th Floor, One Landmark Square, Stamford, CT, 06901-2682, US

(21) Appl. No.: 11/827,005

(22) Filed: Jul. 10, 2007

(30) Foreign Application Priority Data
Jul. 12, 2006 (TW) 095125443

(51) Int. Cl. B60Q 1/06

(52) U.S. Cl. 362/465

(57) ABSTRACT

A vehicular rotatable lamp assembly includes a main frame, a lighting unit including a rotatable lamp seat holder connected pivotally to the main frame and having a gear-toothed plate, and a drive mechanism including a motor mounted on the main frame for rotating the lamp seat holder to a predetermined angle, a motor gear connected to the motor, and a correction gear meshed between the motor gear and the gear-toothed plate. An angle correction mechanism includes an angle indicator rotating along with the correction gear for indicating a rotating angle of the correction gear, and an angle sensor for detecting the rotating angle of the correction gear. A control unit controls the motor to correct an angular position of the lamp seat holder when the rotating angle detected by the angle sensor is not consistent with the predetermined angle.

### CROSS-REFERENCE TO RELATED APPLICATION

This application claims priority of Taiwanese Application No. 095125443, filed on Jul. 12, 2006.

### BACKGROUND OF THE INVENTION

1. Field of the Invention

This invention relates to a vehicular lamp, more particularly to a vehicular rotatable lamp assembly that has a lamp seat holder which rotates synchronously with the turning of a vehicle.

2. Description of the Related Art

Conventional vehicular lamps are fixed to the front sides of a vehicle. When the vehicle is traveling along a curve in the road or around a corner, since the lamps cannot rotate in a manner associated with the turning of the vehicle, the driver is usually not able to accurately grasp the condition of the road surface. This poses significant risks during driving, especially when the vehicle is traveling along a mountain road with no street lamps or is turning a sharp corner.

In order to resolve the aforementioned drawbacks, the applicant has developed many vehicular rotatable lamps, such as those disclosed in Taiwanese Publication Nos. 534023 and 532312, and U.S. Pat. No. 6,767,119. The aforementioned vehicular rotatable lamps can enhance safety when driving along a curve in the road or around a corner. However, these vehicular rotatable lamps are not provided with an angle correction mechanism to correct a rotating angle of a lamp seat holder, so that when the position of the lamp seat holder is changed due to an external force during use, correction of such undesirable displacement does not occur and the lamp seat holder remains in this incorrect position.

### SUMMARY OF THE INVENTION

Therefore, the object of the present invention is to provide a vehicular rotatable lamp assembly that has an angle correction mechanism to correct accurately a rotating angle of a lamp seat holder so that the lamp seat holder is always maintained in the proper position.

According to this invention, a vehicular rotatable lamp assembly comprises a main frame, a lighting unit, a drive mechanism, an angle correction mechanism, and a control unit. The lighting unit includes a rotatable lamp seat holder connected pivotally to the main frame and having a gear-toothed plate, and a lamp seat connected to and rotating synchronously with the lamp seat holder. The drive mechanism includes a motor mounted on the main frame for rotating the lamp seat holder to a predetermined angle, a motor gear connected to the motor, and a correction gear meshed between the motor gear and the gear-toothed plate. The angle correction mechanism includes an angle indicator rotating along with the correction gear for indicating a rotating angle of the correction gear, and an angle sensor disposed adjacent to the angle indicator for detecting the rotating angle of the correction gear. The control unit is connected to the motor and the angle sensor, and controls the motor to correct an angular position of the lamp seat holder when the rotating angle detected by the angle sensor is not consistent with the predetermined angle.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a vehicular rotatable lamp assembly according to the preferred embodiment of the present invention;

FIG. 2 is a schematic view of the preferred embodiment;

FIG. 3 is a partly sectional view of the preferred embodiment taken along line III-III of FIG. 2; and

FIG. 4 is a schematic top view of the preferred embodiment with an outer cover of an angle correction mechanism removed for clarity's sake.

### DETAILED DESCRIPTION OF THE PREFERRED EMBODIMENT

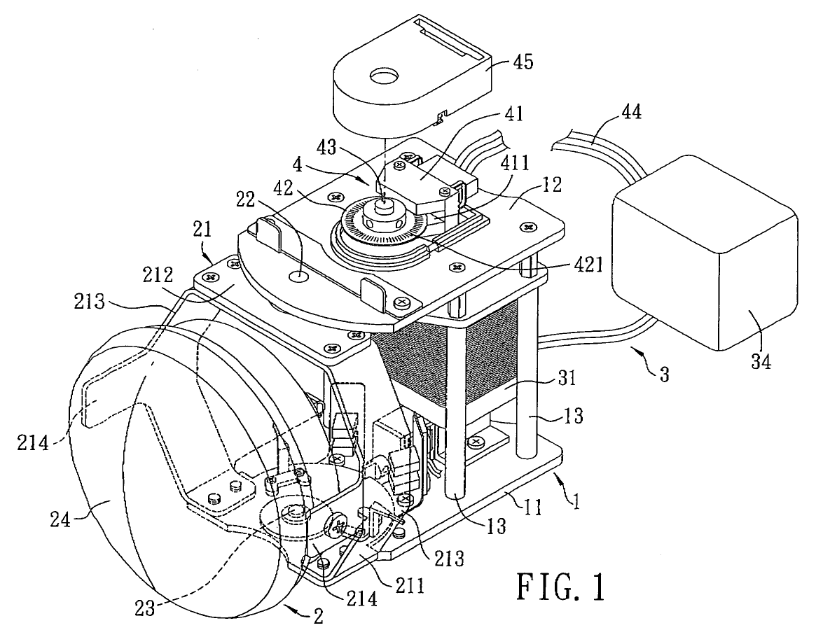

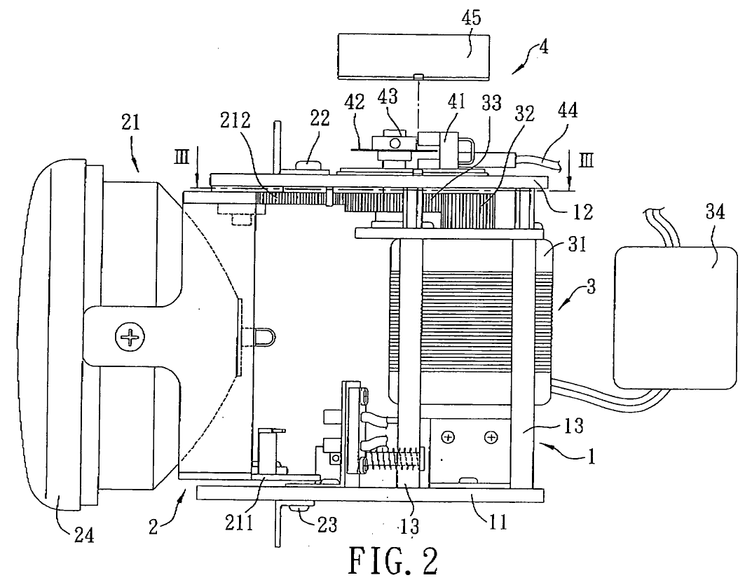

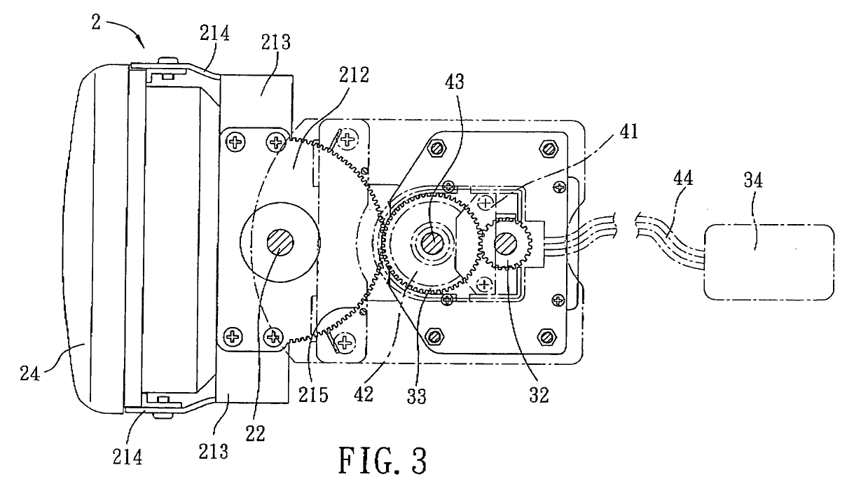

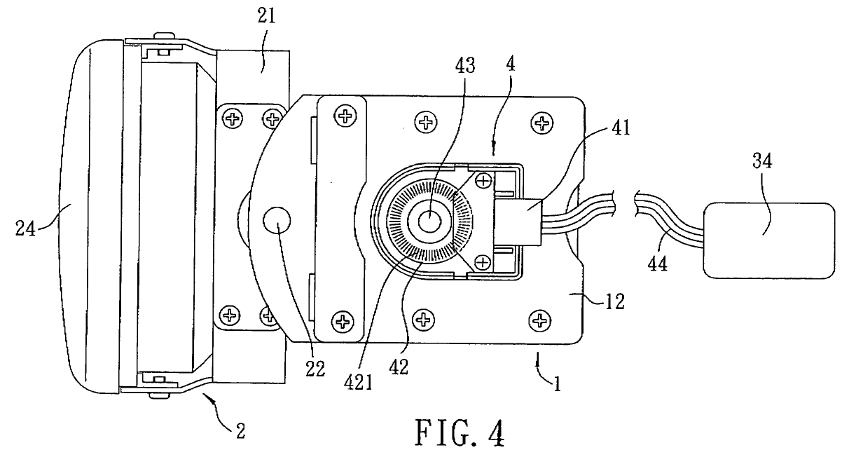

Referring to FIGS. 1 to 4, a vehicular rotatable lamp assembly according to the preferred embodiment of the present invention is shown to comprise a main frame 1, a lighting unit 2, a drive mechanism 3, an angle correction mechanism 4, and a control unit 34.

The main frame 1 is adapted to be installed in a vehicle (not shown), and includes a horizontal bottom plate 11, a top plate 12 spaced apart from and parallel to the bottom plate 11, and a plurality of support rods 13 connected between the bottom and top plates 11, 12.

The lighting unit 2 includes a rotatable lamp seat holder 21 connected pivotally to the main frame 1 and having a horizontal positioning plate 211 disposed above the bottom plate 11, a gear-toothed plate 212 that is parallel to the positioning plate 211 and that is disposed proximate to and below the top plate 12, and two curved side plates 213 connected between the positioning plate 211 and the gear-toothed plate 212. Each of the curved side plates 213 has a lug portion 214 extending forwardly therefrom.

The lighting unit 2 further includes an upper pivot pin 22 extending into the gear-toothed plate 212 and the top plate 12, a lower pivot pin 23 extending into the bottom plate 11 and the positioning plate 211 and cooperating with the upper pivot pin 22 to connect pivotally the lamp seat holder 21 to the main frame 1, and a lamp seat 24 screwed to the lug portions 214 of the curved side plates 213 so as to rotate synchronously with the lamp seat holder 21. The center lines of the upper and lower pivot pins 22, 23 are aligned with each other. The gear-toothed plate 212 has a toothed face 215 extending around the center line of the pivot pin 22.

The drive mechanism 3 includes a motor 31 mounted on the main frame 1 for rotating the lamp seat holder 21 to a predetermined angle, a motor gear 32 connected to and driven by the motor 31, and a correction gear 33 disposed below the top plate 12 and meshed between the toothed face 215 of the gear-toothed plate 212 and the motor gear 32. Preferably, the motor 31 is a step motor.

The angle correction mechanism 4 is installed on the top plate 12 of the main frame 1, and includes an angle indicator 42, a shaft 43, an angle sensor 41, and an outer cover 45. The shaft 43 extends through the top plate 12, and is connected drivingly to the angle indicator 42 and the correction gear 33, so that the angle indicator 42 rotates along with the correction gear 33 for indicating a rotating angle of the correction gear 33. The angle sensor 41 is disposed adjacent to the angle indicator 42 for detecting the rotating angle of the correction gear 33, and has a receiving space 411. The angle indicator 42 includes a graduated disc rotatable about the shaft 43 and having graduation markings 421 extendable into the receiving space 411 so as to be detected by the angle sensor 41. The outer cover 45 covers the angle sensor 41 and the angle indicator 42.

The control unit 34 is connected electrically to the motor 31 and the angle sensor 41. A signal wire unit 44 is connected electrically to the angle sensor 41 and the control unit 34.

The motor 31 is controlled by the control unit 34, and receives a signal from the control unit 34 that may be a function of a turning angle of the vehicle, so that the motor 31 can activate the lamp seat holder 21 and the lamp seat 24 to rotate synchronously with the vehicle through meshing of the motor gear 32 with the correction gear 33, which in turn meshes with the gear teeth 215 of the gear-toothed plate 212. The turning angle of the vehicle may be determined on the basis of a steering wheel angle or the displacement of any component that is moved directly or indirectly by the steering wheel. The motor 31 is also controlled by the control unit 34 to correct an angular position of the lamp seat holder 21 when the rotating angle detected by the angle sensor 41 is not consistent with the predetermined angle.

Under a normal use state, a change in the turning angle of the vehicle results in activation of the motor 31 by the control unit 34. Through meshing of the motor gear 32 with the correction gear 33, which in turn meshes with the toothed face 215 of the gear-toothed plate 212, the lighting unit 2 is rotated synchronously.

When the lighting unit 2 encounters an external force, for example, a large vibrational force generated when the vehicle travels along a bumpy road, the lighting unit 2 is vibrated so that the lamp seat holder 21 together with the lamp seat 24 may be displaced from a normal position. This displacement results in rotation of the gear-toothed plate 212, the correction gear 33, and the motor gear 32. Since the angle indicator 42 rotates along with the correction gear 33, the rotating angle of the correction gear 33 is indicated by the angle indicator 42 and is sensed by the angle sensor 41. The angle sensor 41 then transmits a detection signal to the control unit 34 through the signal wire unit 44 for the control unit 34 to compare the data. When the control unit 34 finds that the rotating angle of the correction gear 33 is not consistent with the turning angle of the vehicle, the control unit 34 activates the motor 31 to rotate by an appropriate amount and in an appropriate direction to thereby correct an angular position of the lamp seat holder 21 and the lamp seat 24. As such, the angular position of the lamp seat holder 21 and the lamp seat 24 is consistent with the turning angle of the vehicle.

Specifically, for example, if the vehicle turns 20° to the left, the control unit 34 activates the motor 31 to also cause the lighting unit 2, i.e., the lamp seat holder 21 and the lamp seat 24, to turn by 20° to the left. However, if the lamp seat holder 21 and the lamp seat 24 are turned further by 2° undesirably to the right due to an external force as discussed above, the abnormal turning of the lamp seat holder 21 and the lamp seat 24 can be detected by the angle sensor 41 due to displacement of the correction gear 33, which meshes with the gear-toothed plate 212, and the corresponding displacement of the angle indicator 42. The angle sensor 41 then transmits the detection signal to the control unit 34. When the control unit 34 finds that there is inconsistency between the received detection signal and the predetermined angle to which the lamp seat holder 21 is rotated by the motor 31, which is a function of the actual turning angle of the vehicle, the control unit 34 will again control the motor 31 so as to correct an angle of deviation (of the lamp seat holder 21 and the lamp seat 24) to the proper angle. As such, the lamp seat holder 21 and the lamp seat 24 are rotated back to an appropriate angle that corresponds correctly to the turning angle of the vehicle. Hence, the present invention not only constitutes a novel structure, it can also continuously correct the rotating angle of the lighting unit 2, so that the lighting unit 2 is always maintained in the proper position.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A vehicular rotatable lamp assembly, comprising:
a main frame;
a lighting unit including a rotatable lamp seat holder connected pivotally to said main frame and having a gear-toothed plate, and a lamp seat connected to and rotating synchronously with said lamp seat holder;
a drive mechanism including a motor mounted on said main frame for rotating said lamp seat holder to a predetermined angle, a motor gear connected to said motor, and a correction gear meshed between said motor gear and said gear-toothed plate;
an angle correction mechanism including an angle indicator rotating along with said correction gear for indicating a rotating angle of said correction gear, and an angle sensor disposed adjacent to said angle indicator for detecting the rotating angle of said correction gear; and
a control unit connected to said motor and said angle sensor and controlling said motor to correct an angular position of said lamp seat holder when the rotating angle detected by said angle sensor is not consistent with the predetermined angle.

2. The vehicular rotatable lamp assembly of claim 1, wherein said angle correction mechanism further includes a shaft connected drivingly to said angle indicator and said correction gear, and a signal wire unit connected electrically to said angle sensor and said control unit.

3. The vehicular rotatable lamp assembly of claim 2, wherein said angle sensor has a receiving space, said angle indicator including a graduated disc rotatable about said shaft and extendable into said receiving space to be detected by said angle sensor.

4. The vehicular rotatable lamp assembly of claim 1, wherein said angle correction mechanism further includes an outer cover covering said angle sensor and said angle indicator.

5. The vehicular rotatable lamp assembly of claim 2, wherein said main frame includes a bottom plate, a top plate spaced apart from said bottom plate, and a plurality of support rods connected between said bottom and top plates, said correction gear being disposed below said top plate, said angle indicator being disposed on said top plate, said shaft extending through said top plate so as to interconnect said angle indicator and said correction gear.

6. The vehicular rotatable lamp assembly of claim 5, wherein said lamp seat holder is pivoted to said top and bottom plates of said main frame, and said gear-toothed plate is proximate to said top plate.
